(19) United States
(12) Patent Application Publication
(10) Pub. No.: US 2013/0119633 A1
(43) Pub. Date: May 16, 2013

(54) MOUNTING SYSTEM FOR A WHEEL OF A BICYCLE

(71) Applicant: Jochen Klieber, Tacherting (DE)

(72) Inventor: Jochen Klieber, Tacherting (DE)

(21) Appl. No.: 13/673,038

(22) Filed: Nov. 9, 2012

(30) Foreign Application Priority Data
Nov. 11, 2011 (DE) 10 2011 086 180.7

(51) Int. Cl. B60B 1/00

(52) U.S. Cl. CPC B60B 1/003
USPC 280/281.1; 301/124.2; 301/55

(57) ABSTRACT

A mounting system is provided for releasably mounting a bicycle wheel that includes, but is not limited to an axle body and tool holder. The axle body is configured for receiving a hub of a wheel and comprises a first and second end for mounting retaining devices of a bicycle frame. The axle body, at the second end, includes, but is not limited to an external thread for screwing into a receiving aperture of a frame element with a matching internal thread. The axle body, at the first end, includes, but is not limited to an attachment device for attaching a tool in order to be able to screw-in the axle body with the external thread for releasably mounting the wheel. An axially extending cavity provided in the axle body serves as a tool holder intended to at least partially receive a tool for mounting and releasing the axle body.

### CROSS-REFERENCE TO RELATED APPLICATION

This application claims priority to German Patent Application No. 10 2011 086 180.7, filed Nov. 11, 2011, which is incorporated herein by reference in its entirety.

### TECHNICAL FIELD

The technical field relates to a mounting system for releasably mounting a wheel for a bicycle, to a wheel for a bicycle as well as to a bicycle.

### BACKGROUND

It is known to use for example, quick-release systems for releasably mounting a wheel on bicycles. The clamping forces required to support a wheel or a wheel axle are brought about by turning over a quick-release lever. It has been shown, however, that in particular in the mountain-bike field, better supporting forces and in particular an improved stiffness of the frame or the fork, can be achieved by wheel axles that can be screwed into the frame. The screw-in force is applied by a tool. However, it has been shown that for example in amateur or professional racing a tire change may be required during the race which makes it desirable for the corresponding wheel to be exchanged as quickly as possible. One disadvantage with known solutions has for example been that the required tool for unscrewing or tightening the axle is carried in an accompanying rucksack and therefore has to be found first and removed.

In view of the foregoing, at least one object therefore is to provide a mounting system which permits faster assembly and disassembly of a wheel and at the same time ensures a connection with maximum stiffness. In addition, other objects, desirable features and characteristics will become apparent from the subsequent summary and detailed description, and the appended claims, taken in conjunction with the accompanying drawings and this background.

### SUMMARY

According to a first embodiment, a mounting system is provided for releasably mounting a wheel for a bicycle. The mounting system comprises an axle body and a tool holder. The axle body is configured to receive a hub of a wheel and comprises a first and a second end for mounting in retaining devices of a bicycle frame. At a second end, the axle body comprises an external thread for screwing into a receiving aperture of a frame element with a matching internal thread. At a first end, the axle body comprises an attachment device for attaching a tool in order to be able to screw-in the axle body with the external thread for releasably mounting the wheel. A tool holder is provided in the axle body in the form of an axially extending cavity for at least partially receiving a tool for mounting and releasing the axle body.

The provision of a tool holder formed integrally with the axle body offers the advantage of being able to accommodate the tool in the immediate vicinity of its intended primary use. As a result there is no longer any need for searching for a tool, and in addition it ensures that a tool is always at hand for releasing the wheel. At the same time optimum stability of the axle body is ensured due to the fact that this can be screwed into a bicycle frame or into the intended receiving devices.

According to one embodiment, a tool retaining device is provided for unloosably retaining the tool in the received state. For example, the tool retaining device may be provided on the axle body itself. According to a further embodiment, the tool retaining device is provided on a frame segment of the bicycle frame in the immediate vicinity of the receiving apertures for the axle body.

According to one embodiment, the axle body is configured as a through-axle for mounting a wheel. With a plug-in shaft, for example, the axle body comprises a shaft section between the first end and the second end, which in the mounted state of the plug-in shaft extends between a first dropout and a second dropout of a frame or a fork and which serves to receive the hub. A radially projecting shoulder is arranged at the first end of the axle body, through which, in the mounted state, a force is transferred, which is effective in parallel with the direction of the centre axis of the shaft section. The shoulder, in the mounted state, is supported against a corresponding abutment surface, which is arranged at the first dropout.

Conically formed force transfer elements may, for example, be provided between the shoulder and the abutment surface at the dropout, which elements may, for example, be slotted or at least partially slotted.

The tool may, for example, be insertable, i.e., it may be inserted into the cavity from the side of the first end. Alternatively, the tool may be inserted from the side of the second end. Or both variants may be provided jointly.

At the first end, the axle body may, for example, be provided with a collar projecting in axial direction, into which a tool to be retained may be inserted with a clamping insert. On its inside the collar may comprise an O-ring inserted into a groove for holding the clamping insert. At the end not comprising a tool holder, the axle body may comprise a cover for closing the front of the internal cavity.

According to a further embodiment, a tool is provided for screwing the axle body into and out of the tool holder, which tool can be completely removed from the tool holder.

According to a further embodiment, the tool is at least partially inserted into the retaining device. The tool comprises a primary tool point that is configured so as to provide a force-locked connection with the attachment device of the axle body. The tool comprises a lever arm device for exerting a torque upon the axle body. The tool is removably held in the retaining device.

According to a further embodiment, the tool for the lever arm device is L-shaped with a first and a second side portion and is inserted into the retaining device with one of the two side portions. At a transition from the first to the second side portion, the tool is configured with a multi-functional handle device with which the tool can be inserted into and removed from the retaining device. With the tool retained, i.e., with the tool inserted into the tool holder, the multi-functional handle device may, for example, seal the attachment device against impurities. The multi-functional handle device may, for example, be provided with a clamping insert, which can be inserted into a collar projecting in axial direction from the first end of the axle body, in order to hold the tool.

The clamping insert may comprise a cross-sectional form increasing in direction of the inserted end in order to urge the tool in direction of the axle body, which means safe support. With the tool held, the clamping insert seals the receiving aperture and the axle body at the face against impurities.

The multi-functional handle device may, for example, be equipped with a stop for attaching the tool to the axle body or for placing it into the tool retaining device on the axle. The multi-functional handle device may, for example, comprise two handle devices facing each other. A first projecting handle may, for example, be provided on at least one side and a second projecting handle may be formed on the opposite side by one of the two lever arms.

According to a further embodiment, the multi-functional handle device is equipped with a clamping insert, which can be inserted into a recess on the axle body. The clamping insert seals the front of the receiving aperture and the axle body against impurities and also comprises a stop for attaching the tool to the attachment device of the axle body. The multi-functional handle device further comprises two handle devices arranged opposite to each other. One of the projecting handles is formed by one of the two lever arms.

At the end of the first side portion the tool may comprise a first tool point and at the end of the second side portion it may comprise a second tool point. The first tool point is formed as the primary tool point and is different from the second tool point.

According to a further embodiment, the attachment device of the axle body comprises a through-going plug-in aperture for receiving the primary tool point. The primary tool point, in the received state, is in engagement with the attachment device. The tool is held by inserting it into the plug-in aperture with the second side portion.

The state or the position in which the primary tool point is received in the attachment device and in which it is in engagement with the same, is also called the working position. The position, in which the tool is inserted with the second side portion into the plug-in aperture, is also called the holding position.

The second side portion may, for example, have a cross-section which matches the opening cross-section of the aperture of the attachment device, for example, the second side portion may also be shaped as an external hexagon. The second tool point may also be shaped as an external hexagon, for example, so as to match the attachment device also or it may be of another size for other screw connections on the bicycle.

The second side portion may also have a different cross-section, for example a round one or with longitudinally extending projections. With a round form or a form which circumferentially is smaller than the inner circular clearance of the attachment device, the tool can be turned, when in the received state. With profiles, i.e., aperture profile of the attachment device and cross-sectional profile of the second side portion, the tool can no longer be turned, when in the received state, unless the area of the second side portion, which in the inserted state is arranged in the aperture of the attachment device, is given a smaller cross-sectional form (see above).

The primary tool point may also be formed in the shape of another connection or plug-in connection system, for example as a torx. The attachment device of the axle body will then have a shape to match.

At the plugged-in lever arm in the area of the plug-in aperture the tool may be circumferentially smaller than the plug-in aperture such that the plugged-in lever arm is rotatably held. At the plugged-in lever arm in the area of the plug-in aperture, the tool may comprise a circumferential contour with a plurality of projections. The plurality is a multiple of the projections of the plug-in aperture. The plugged-in lever arm has a plurality of matching projections. The axial angular position of the tool can be more finely adjusted than in the case where adjustment is performed by means of the projections of the plug-in aperture. At the plugged-in lever arm in an area, which adjoins the area of the plug-in aperture, the tool may comprise a circumferential form which is smaller than the plug-in aperture such that the plugged-in lever arm is rotatably held.

According to a further embodiment, the mounting system comprises a first and a second holder at the dropout and/or fork end for receiving an axle body of a wheel. An additional tool holder device may be provided at a frame segment in the vicinity of one of the two holders.

The mounting system may be provided for a front wheel or a rear wheel or for both a front wheel and a rear wheel. The mounting system may, for example, be provided for a front wheel and the rear wheel on a bicycle. One of the two tool holders, such as the cavity on the axle body of the front wheel or the cavity on the axle body of the rear wheel, may be closed off by a detachable cover as protection against impurities. The releasably held tool in the other tool holder may be used for mounting and releasing both wheels.

The additional tool retaining device may be a clamp for receiving a part of the tool. An additional tool retaining device may be provided in the frame element in the form of a recess for receiving a projection which is formed on the tool. The first holder at the dropout and/or fork end may be configured such that the axle body can be inserted and partially passed-through, and the second holder may be configured with an internal thread into which the axle body can be screwed. A recess for inserting a clamping insert of the tool may be provided on the frame element in the area of the first or second holder. A collar protruding in axial direction of the axis may be provided on the frame element in the area of the first or second holder, whereby a tool to be held may be inserted into the collar with the clamping insert.

According to a second embodiment, a wheel for a bicycle is provided which comprises a wheel rim, a plurality of spokes, a hub and an axle body. The wheel rim is held on the hub by the spokes, and the hub is received in the axle body. A mounting system is provided according to one of the previously described mounting systems.

According to a third embodiment, provision is made for a bicycle with a frame, a fork and two wheels. At least one of the wheels is configured as previously described.

According to one embodiment, provision is made to store the tool for releasing and mounting the axle, which is screwed into a thread at the dropout or the fork end, in the immediate vicinity in order to ensure that the tool is readily accessible at any time. To this effect a cavity is formed on the axle body, into which the tool can be plugged in at least partially. A normal tool can still be used for screwing-in and unscrewing the axle body, which tool is fitted with the matching plug-in system for transferring the operation for releasing and mounting the axle body.

The plugged-in tool may comprise a lever arm for exerting the necessary retention force and is fitted, for example, with a handle device that fulfils several functions simultaneously, so that in particular, stronger shocks can be endured as are likely, for example, in the context of mountain biking. In addition, a stop is provided which is used to insert the tool into the corresponding aperture or attachment device of the axle body, and at the same time to ensure that the tool engages with the attachment device such that a secure transfer of force is possible. In this way the tool can be very quickly attached since there is no need for the user to first check that the key has been plugged in far enough. At the same time the stop is configured in such a way that a sufficient distance to adjoining frame elements is ensured in order to protect the user from getting his fingers caught between the tool and the frame elements. The handle device is further configured with two opposite projections by means of which the tool can be pulled out in axial direction. If only one handle is provided, an unfavourable lever torque may occur resulting in the tool becoming jammed in the axle.

It is pointed out that the features of the embodiments can be combined freely with one another also in cases where this has not been explicitly mentioned.

### BRIEF DESCRIPTION OF THE DRAWINGS

Embodiments of the invention will now be explained in detail with reference to the attached drawings, in which:

FIG. 1 shows a bicycle according to one embodiment;

FIG. 2 shows a wheel according to one embodiment;

FIG. 3 shows a mounting system for releasably mounting a wheel for a bicycle according to one embodiment;

FIG. 4 shows the mounting system of FIG. 3 with a plugged-in tool;

FIG. 5 shows a further embodiment of a mounting system;

FIG. 6 shows the mounting system of FIG. 5 with a plugged-in tool;

FIG. 7 shows a further embodiment of a mounting system in conjunction with two fork ends;

FIG. 8 shows the mounting of FIG. 6 with the tool in the operating position for releasing of tightening the axle body;

FIG. 9 shows a further perspective view of the mounting system shown in FIG. 7;

FIG. 10 shows a further embodiment of a mounting system with schematically indicated dropouts;

FIG. 11 shows a tool of a mounting system;

FIG. 12 shows a further embodiment of a mounting system;

FIG. 13 shows a further embodiment of a mounting system;

FIG. 14 shows a further embodiment for a tool of a mounting system; and

FIG. 15 shows a further embodiment for a tool of a mounting system.

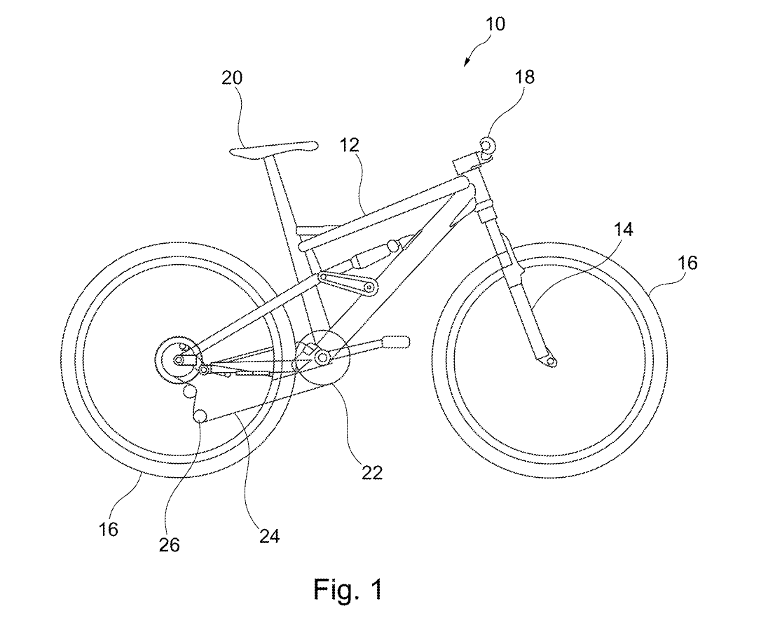

### DETAILED DESCRIPTION

The following detailed description of the invention is merely exemplary in nature and is not intended to limit application and uses. Furthermore, there is no intention to be bound by any theory presented in the preceding background or summary or the following detailed description.

Provision is made for at least one of the wheels 16 to be equipped with a mounting system for releasably mounting a wheel for a bicycle, which will now be explained in detail with reference to the following figures.

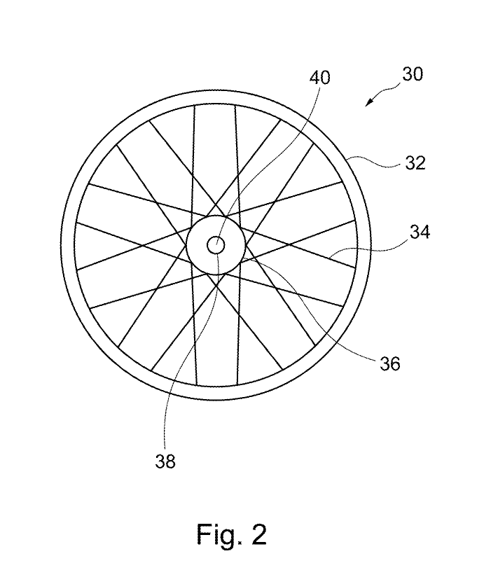

Before the mounting system is discussed FIG. 2 will be briefly explained. FIG. 2 shows a wheel 30 for a bicycle with a wheel rim 32, a plurality of spokes 34, a hub 36 and an axle body 38. The wheel rim 32 is held on the hub 36 by the spokes 34, and the hub is received on the axle body. A mounting system 40 is provided, which is not shown in detail in FIG. 2, but will be explained in detail with reference to the following figures showing various exemplary embodiments.

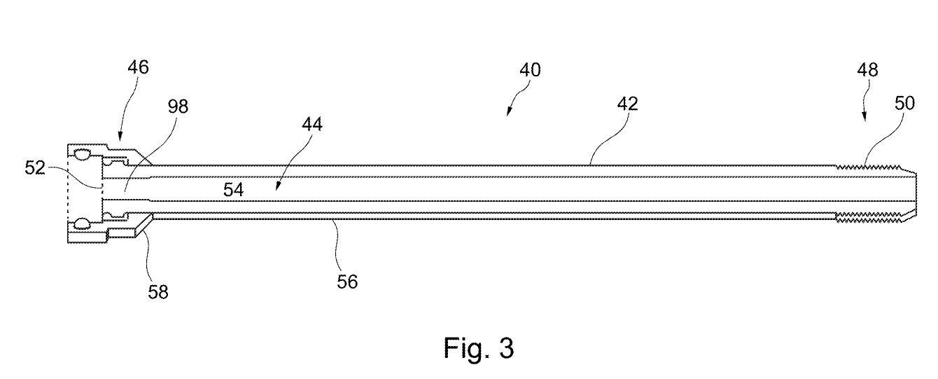

FIG. 3 shows a longitudinal section of the mounting system 40 for releasably mounting a wheel for a bicycle. The mounting system comprises an axle body 42 and a tool holder 44.

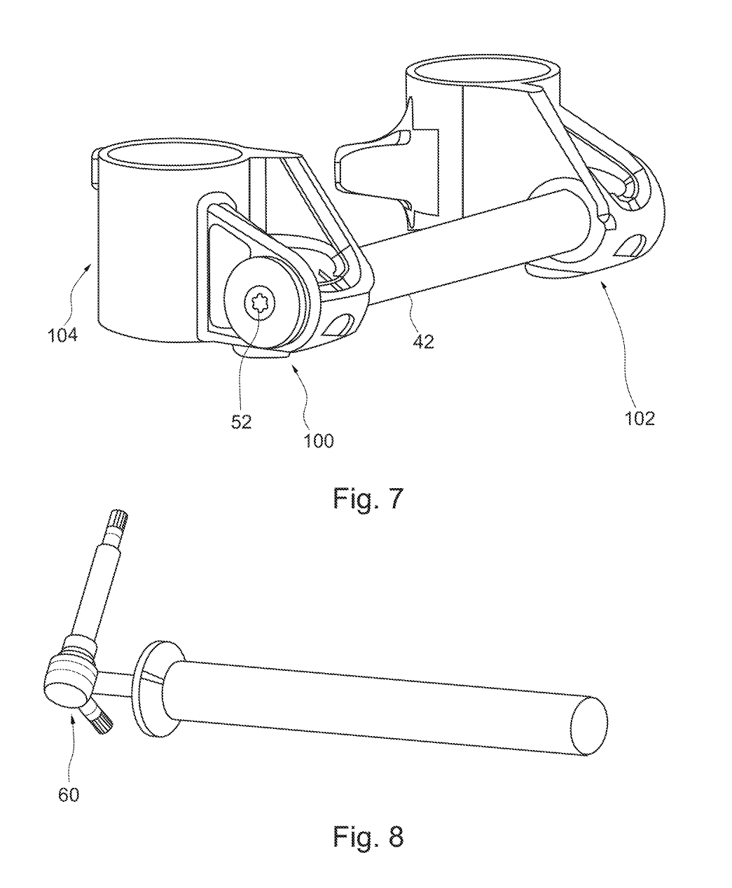

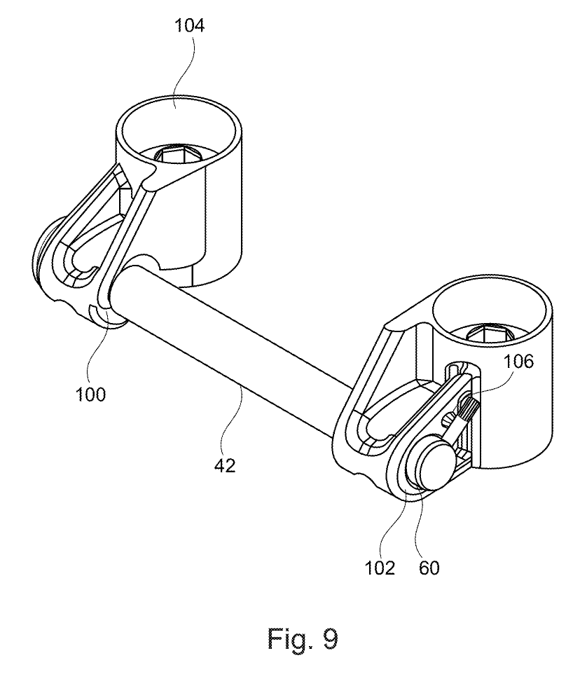

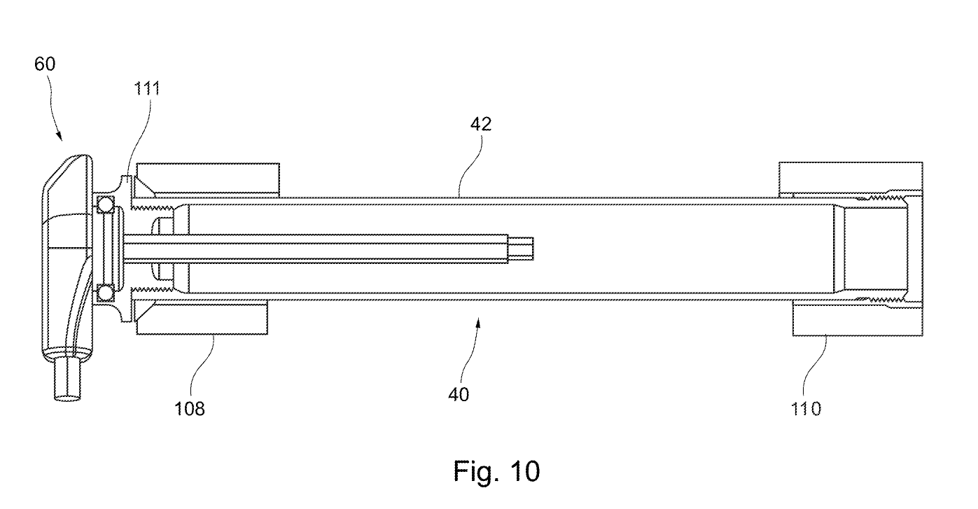

The axle body 42 is configured to receive a hub of a wheel and comprises a first end 46 and a second end 48 for mounting in retaining devices of a bicycle frame (see for example FIG. 7, FIG. 9 and FIG. 10). The second end 48 of the axle body comprises an external thread, 50 which is intended for screwing into a receiving aperture of a frame element with a matching internal thread. At its first end 46 the axle body 42 comprises an attachment device 52 for attaching a tool suitable for screwing or unscrewing the axle body with the external thread for releasably mounting a wheel.

A cavity 54 extending axially in the axle body 42 serves as a tool holder 44 for at least partially receiving a tool for mounting and releasing the axle body. The axle body may be formed as a through-axle for mounting a wheel, for example a wheel of a mountain bike.

To this end the axle body 42 comprises a shaft section 56 between the first end 46 and the second end 48, which in the mounted state of the through-axle extends between a first dropout and a second dropout of a frame or a fork, and which serves to receive the hub. A radially projecting shoulder 58 is arranged at the first end, through which, in the mounted state, a force is transferred which is effective in parallel with the direction of the centre axis of the shaft section, wherein the shoulder in the fitted state is supported against a corresponding abutment surface, which is arranged at the first dropout of the frame.

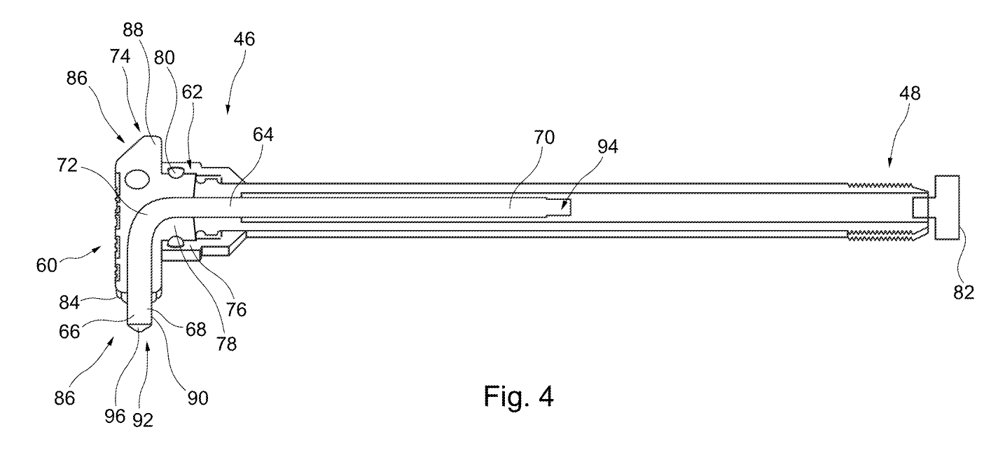

FIG. 4 shows the mounting system 40 of FIG. 3. A tool 60 is provided, which, for screwing and unscrewing the axle body, can be removed completely from the tool holder. In FIG. 4 the tool 60 is inserted, for example, into the cavity 54 from the side of the first end 46.

The mounting system 40 comprises a tool retaining device 62 for securely and unloosably retaining the tool in the received state. The tool 60 is, for example, equipped with a lever arm device 64 for exerting a torque upon the axle body. To this end the tool may be removed from the retaining device, in which it is removably but securely retained. The tool 60 comprises a primary tool point 66, which is shaped so as to form a force-locked connection with the attachment device 52 of axle body 42. The tool 60 is configured, for the lever arm device 64, with a first side portion 68 and a second side portion 70 and is inserted with one of the two side portions into the retaining device.

At a transition 72 from the first 68 to the second side portion 70, the tool 60 is configured with a multi-functional handle device 74, with which the tool can be placed into and removed from the retaining device. The retaining device 62 may, for example, be an aperture on a front end of the axle body. The axle body 42 may, for example, comprise a collar 76 projecting in axial direction from a first end 46, into which collar the tool 60 to be held may be inserted with a clamping insert 78 formed on the multi-functional handle device 74.

The collar 76, on the inside, may comprise an O-ring inserted into a groove for retaining and simultaneously sealing the clamping insert. At the second end the axle body may comprise a front cover 82 covering the internal cavity. With the tool held, the multi-functional handle device 74 seals the attachment device of the axle body against impurities.

The clamping insert may comprise a cross-sectional form 81 which increases in direction of the inserted end in order to urge the tool in direction of the axle body, for secure holding. In addition to sealing, the multi-functional handle device fulfils further functions. To this end the multi-functional handle device 74 is equipped with a stop 84 for attaching the tool 60 to the axle body 42. In addition, the multi-functional handle device comprises two handle devices 86 arranged opposite to each other. At one side that is provided opposite the first side portion 68, a first projecting handle 88 is formed and the first side portion 68 serves as opposite second projecting handle 90.

At the end of the first side portion 68, the tool 60 may be formed with first tool point 92 and at the end of the second side portion; it may be formed with a second tool point 94. The first tool point may differ from the second tool point. The tool 60 comprises a primary tool point 96, which is configured to provide the force-locked connection with the attachment device of the axle body. The primary tool point 96 may, for example, be shaped as an external hexagon, with the attachment device 52 of axle body 42 being a matching internal hexagon. The attachment device may comprise a though-going plug-in aperture 98, and the tool 60 is inserted into the plug-in aperture with the second side portion.

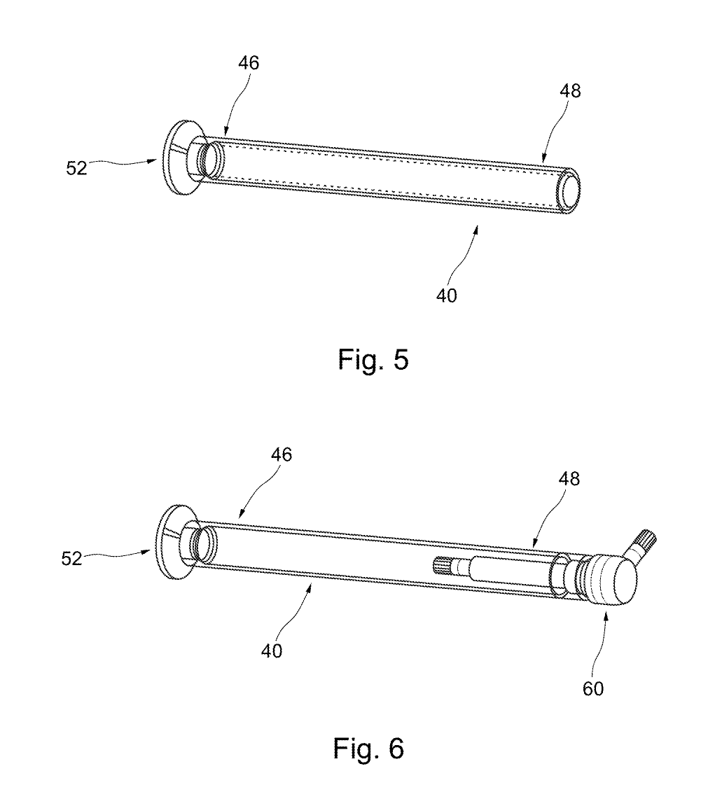

FIG. 5 shows an embodiment of the mounting system 40. The tool 60 is inserted into the cavity from the side of the second end. For example at one or at both the tool points, the tool may be shaped as a torx connection, such as can be seen also in FIG. 6, which is the mounting system according to FIG. 5, with the tool inserted.

FIG. 7 shows the mounting system 40 in conjunction with a first holder 100 and a second holder 102 at one fork end 104 for receiving the axle body 42 of a wheel not further shown in detail. In the perspective drawing in the left-hand frontal area, the attachment device 52 is shown, which, as an example, is configured with a torx here.

FIG. 8 shows the mounting system 40 of FIG. 6, wherein the tool 60 is inserted into the attachment device 52 with the primary tool point.

FIG. 9 shows the mounting system 40 with the two fork ends of FIG. 7 in another perspective view. As can also be seen in FIG. 9, an additional tool retaining device 106 may be provided on a frame segment, such as the fork end with the second holder 102, in the vicinity of one of the two holders.

FIG. 10 shows a further embodiment for a mounting system 40, wherein the mounting system 40 is provided with a first holder 108 and a second holder 110 at the dropout of a frame not shown in detail, for receiving the axle body 42. The axle body 42 serves to receive a wheel not further shown.

FIG. 10 also shows that a holding insert 111 may be provided with the tool 60 inserted. The holding insert 111 is, for example, screwed into the dropout or into a collar projecting from the axle body.

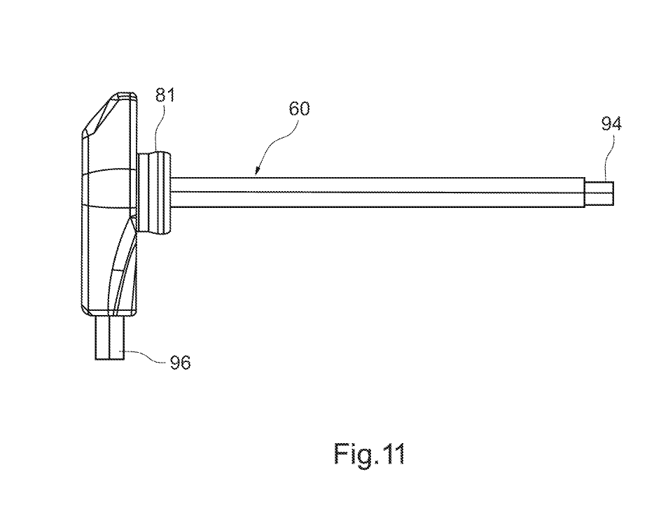

FIG. 11 shows an example for the tool 60 described with reference to the previous figures, where the primary tool point 96 is shaped as a first Allen key and the second tool point 94 is shaped as a further, smaller Allen key.

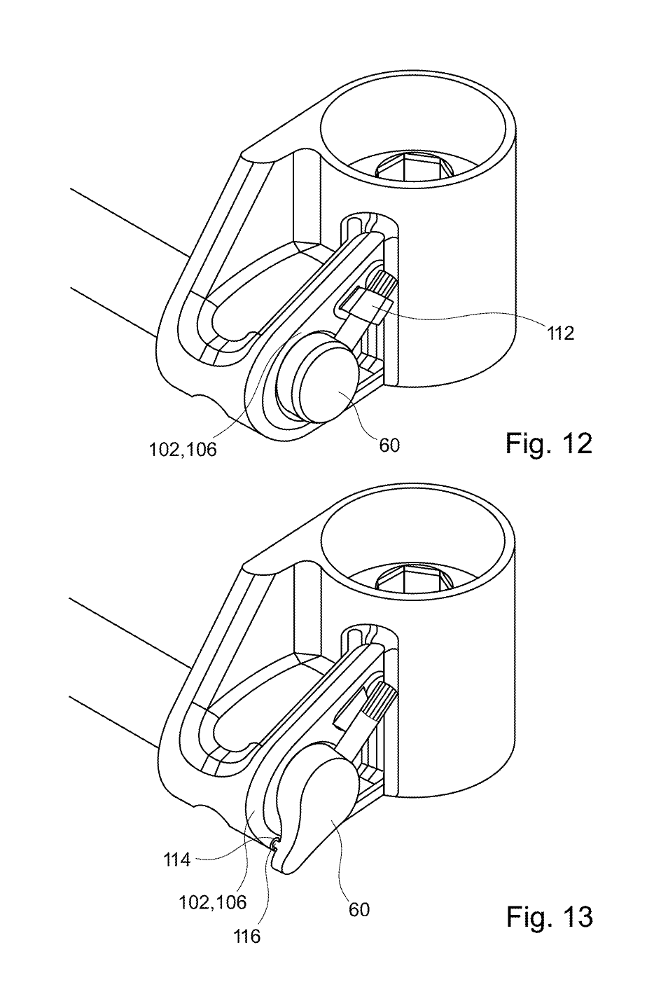

FIG. 12 shows an embodiment for a mounting system. The additional tool retaining device 106 is a clamp 112 for receiving part of the tool.

According to the exemplary embodiment shown in FIG. 13 as an additional tool retaining device 106, a recess 114 is provided for receiving a projection 116 formed on the tool 60.

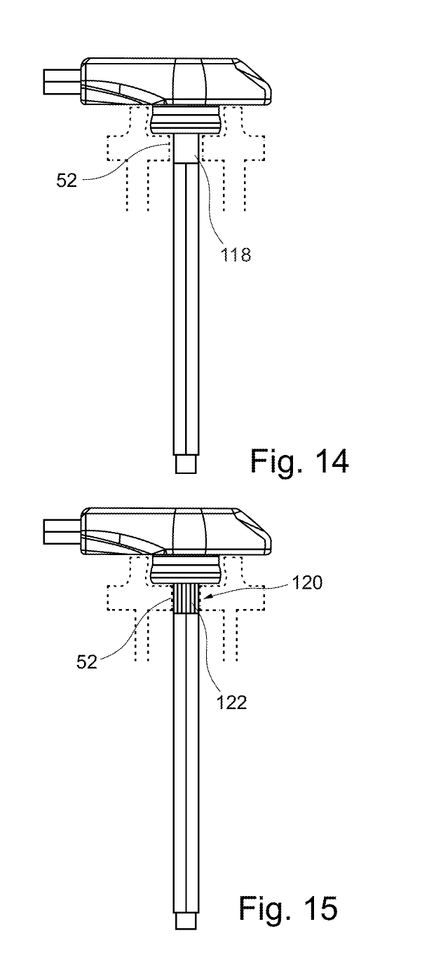

As shown in FIG. 14 the tool 60, on the plugged-in lever arm in the area of the plug-in aperture, may comprise a circumferential form 118 which is smaller than the plug-in aperture so as to rotatably hold the inserted lever arm. This enables, for example, the multi-functional handle device to be aligned according to the surrounding frame segments.

According to the exemplary embodiment shown in FIG. 15, the tool on the inserted lever arm may comprise a circumferential contour 120 with a plurality of projections 122 in the area of the plug-in opening. The plurality is a multiple of the projections of the plug-in opening. The inserted lever arm comprises a plurality of matching projections. The tool in its axial angle position can be adjusted more finely compared to the amount of adjustability by the projections of the plug-in opening. In addition, the tool may comprise a circumferential form in an area adjoining the area of the plug-in opening, which is smaller than the plug-in aperture so as to rotatably hold the inserted lever arm.

The exemplary embodiments described above may be combined in various ways. In particular embodiments may be combined for which this has not been explicitly mentioned. Also, it should be mentioned that “comprising” does not exclude any other elements or steps and “one” or “a” does not exclude a plurality. Further, it should be pointed out that features which have been described with reference to one of the above exemplary embodiments and aspects, may also be used in combination with other features of other described exemplary embodiments and aspects. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A mounting system for releasably mounting a wheel for a bicycle, comprising:
an axle body, comprising:
a first end and a second end that are configured to mount in retaining devices of a frame of the bicycle;
an external thread on the second end that is configured to screwing into a receiving aperture of a frame element with a matching internal thread;
an attachment device is configured to attach a tool at the first end in order to screw-in the axle body with the external thread and releasably mount the wheel; and
an axially extending cavity in the axle body that is configured to serve as a tool holder in which the tool can be at least partially received for mounting and releasing the axle body.

2. The mounting system according to claim 1, further comprising a tool-retaining device that is configured to unloosably retain the tool.

3. The mounting system according to claim 1, wherein the axle body is configured as a through-axle for mounting the wheel.

4. The mounting system according to claim 1, further comprising the tool that is configured to screw the axle body into and out of the tool holder,
wherein the tool is completely removable from the tool holder.

5. The mounting system according to claim 4,
wherein the tool is configured for insertion at least partially into a retaining device,
wherein the tool comprises a primary tool point that is configured for connection to the attachment device of the axle body in a force-locked manner,
wherein the tool comprises a lever-arm device that is configured to exert a torque upon the axle body, and
wherein the tool is removably retained in the retaining device.

6. The mounting system according to claim 5,
wherein the tool for the lever-arm device is configured in an L-shape with a first side portion and a second side portion and pluggable into the retaining device with the first side portion, and
wherein the tool, at a transition from the first side portion to the second side portion, is configured with a multi-functional handle device with which the tool is insertable into the retaining device and removed from the retaining device.

7. The mounting system according to claim 6,
wherein the multi-functional handle device is configured with a clamping insert, which is insertable into a recess, into which an axle is insertable,
wherein the receiving aperture and the axle body are substantially sealable at a face against impurities with aid of the clamping insert,
wherein the clamping insert comprises a stop that is configured to attach the tool to the attachment device of the axle body, and
wherein the clamping insert comprises a first handle device arranged opposite a second handle device.

8. The mounting system according to claim 6,
wherein the attachment device of the axle body comprises a through-going insertion opening that is configured to receive the primary tool point,
wherein the primary tool point is in engagement with the attachment device in a received state, and
wherein the tool is insertable with the second side portion into a plug-in aperture.

9. The mounting system according to claim 1,
wherein the mounting system comprises a first holder and second holder that is configured to receive the axle body of the wheel, and
wherein the mounting system further comprises an additional tool retaining device on a frame segment in a vicinity of the first holder.

10. A wheel for a bicycle, comprising:
an axle body;
a hub received on the axle body;
a plurality of spokes;
a wheel rim that is held with the plurality of spokes on the hub; and
a mounting system for releasably mounting the wheel, comprising:
a first end and a second end of the axle body that are configured to mount in retaining devices of a frame of the bicycle;
an external thread on the second end that is configured to screwing into a receiving aperture of a frame element with a matching internal thread;
an attachment device is configured to attach a tool at the first end in order to screw-in the axle body with the external thread and releasably mount the wheel; and
an axially extending cavity in the axle body that is configured to serve as a tool holder in which the tool can be at least partially received for mounting and releasing the axle body.

11. The wheel according to claim 10, further comprising a tool-retaining device that is configured to unloosably retain the tool.

12. The wheel according to claim 10, wherein the axle body is configured as a through-axle for mounting the wheel.

13. The wheel according to claim 10, further comprising the tool that is configured to screw the axle body into and out of the tool holder,
wherein the tool is completely removable from the tool holder.

14. The wheel according to claim 13,
wherein the tool is configured for insertion at least partially into a retaining device,
wherein the tool comprises a primary tool point that is configured for connection to the attachment device of the axle body in a force-locked manner,
wherein the tool comprises a lever-arm device that is configured to exert a torque upon the axle body, and
wherein the tool is removably retained in the retaining device.

15. A bicycle, comprising:
a frame;
a fork; and
a wheel comprising:
an axle body;
a hub received on the axle body;
a plurality of spokes; and
a wheel rim that is held with the plurality of spokes on the hub; and
a mounting system for releasably mounting the wheel, comprising:
a first end and a second end of the axle body that are configured to mount in retaining devices of the frame of the bicycle;
an external thread on the second end that is configured to screwing into a receiving aperture of a frame element with a matching internal thread;
an attachment device is configured to attach a tool at the first end in order to screw-in the axle body with the external thread and releasably mount the wheel; and
an axially extending cavity in the axle body that is configured to serve as a tool holder in which the tool can be at least partially received for mounting and releasing the axle body.

16. The bicycle according to claim 15,
wherein the tool for a lever-arm device is configured in an L-shape with a first side portion and a second side portion and pluggable into a retaining device with the first side portion, and
wherein the tool, at a transition from the first side portion to the second side portion, is configured with a multi-functional handle device with which the tool is insertable into the retaining device and removed from the retaining device.

17. The bicycle according to claim 16,
wherein the multi-functional handle device is configured with a clamping insert, which is insertable into a recess, into which an axle is insertable,
wherein the receiving aperture and the axle body are substantially sealable at a face against impurities with aid of the clamping insert,
wherein the clamping insert comprises a stop that is configured to attach the tool to the attachment device of the axle body, and
wherein the clamping insert comprises two handle devices arranged opposite to each other.

18. The bicycle according to claim 17,
wherein the attachment device of the axle body comprises a through-going insertion opening that is configured to receive a primary tool point,
wherein the primary tool point is in engagement with the attachment device in a received state, and
wherein the tool is insertable with the second side portion into a plug-in aperture.

19. The bicycle according to claim 15,
wherein the mounting system comprises a first holder and second holder that is configured to receive the axle body of the wheel, and
the mounting system further comprises an additional tool retaining device on a frame segment in a vicinity of the first holder.

20. The bicycle according to claim 15, further comprising a tool-retaining device that is configured to unloosably retain the tool.
